(19) United States
(12) Patent Application Publication
(10) Pub. No.: US 2005/0241669 A1
(43) Pub. Date: Nov. 3, 2005

(54) Method and system of dry cleaning a processing chamber

(75) Inventor: Norman Wodecki, Phoenix, AZ (US)

Correspondence Address: PILLSBURY WINTHROP SHAW PITTMAN, LLP, P.O. BOX 10500, MCLEAN, VA, 22102, US

(73) Assignee: Tokyo Electron Limited, Tokyo (JP)

(21) Appl. No.: 10/834,370

(22) Filed: Apr. 29, 2004

(51) Int. Cl. B08B 6/00; B01J 19/08

(52) U.S. Cl. 134/1.1; 134/18; 134/22.1; 422/186.04

(57) ABSTRACT

A method of dry cleaning a plasma processing system is described, wherein the formation of particulate during dry cleaning is substantially minimized. In one embodiment, the dry cleaning process is adjusted in order to substantially reduce spatial variations of the dry cleaning rate within the plasma processing system. In another embodiment, endpoint detection is utilized to determine the completion of the dry cleaning process in order to avoid excessive ion sputtering of the underlying process chamber components.

### BACKGROUND OF THE INVENTION

1. Field of the Invention

The present invention relates to a method and system for dry cleaning a processing chamber, and more particularly to a method and system for dry cleaning a processing chamber while substantially reducing particulate contamination.

2. Description of Related Art

Dry plasma etching has become a critical step in the fabrication of microelectronic circuits on semiconductor substrates, such as silicon wafers. As critical dimensions (CD) of circuits become smaller, device yield becomes more sensitive to particulate defects accumulated on the wafer surface during the fabrication cycle. Contributions to wafer defect density by plasma etching can be minimized by controlling the accumulation of process by-products that condense on exposed etch reactor surfaces in the form of a polymeric deposition.

For example, in conventional dielectric etch applications, polymer deposition is most prominent on the upper surface of the etch reactor facing the substrate, and the substrate holder wall surfaces, and it has been observed that the outer reactor wall accumulates noticeably less polymer deposition. As a result, the distribution of polymer deposition on the interior surfaces of the etch reactor is generally non-uniform.

Polymer deposition, allowed to accumulate over a period of time, can become a source of particulates and polymer flakes that increase contributions to wafer defect density. Periodic oxygen plasma cleans, commonly termed dry cleans (DC), are used to remove accumulated by-product deposition from chamber surfaces, serving to maintain an acceptable wafer defect density and extending the operating time between wet cleans (WC). Typically, polymer deposition is an organic or carbon-based film and, therefore, it is recognized that it is effectively volatilized and removed with an oxygen plasma.

A conventional approach has been to treat a DC application similar to resist ashing with an oxygen plasma, whereby maximized ash rates are achieved with elevated pressure, power, and gas flow rate. Although this process condition is reasonably effective in removing chamber deposition, it has been shown to produce an undesirable amount of other particulate by-products in the form of the chemical make-up of the reactor wall and its coating. For example, reactor walls are generally fabricated of aluminum, and can have a coating including alumina (Al₂O₃) and/or aluminum fluoride (AIF). Consequently, particulate, such as Al₂O₃ and AIF, have been observed to be present in the processing system as a result of excessive ion sputtering of ceramic reactor surfaces. These particulates accumulate and eventually contribute to particle counts measured on the substrate.

### SUMMARY OF THE INVENTION

For these and other reasons, the principles of the present invention, as embodied and broadly described herein, are directed to solve or mitigate any or all of the above described problems, or other problems in the prior art, including the substantial reduction of particulate formation in plasma processing systems and/or the substantial reduction of particulate formation in plasma processing systems during dry cleaning.

According to one embodiment, a method of dry cleaning a plasma processing system is presented comprising selecting a dry cleaning process recipe for substantially reducing particulate contamination during the dry cleaning of the plasma processing system, wherein the dry cleaning process recipe comprises setting at least one of a mass flow rate of a process gas, a pressure for the dry cleaning process, and a power for forming a plasma from the process gas; and executing the dry cleaning process recipe in the plasma processing system to facilitate the dry cleaning.

According to another embodiment, a plasma processing system for processing a substrate is presented comprising a process chamber, a substrate holder coupled to the process chamber and configured to support the substrate, a gas injection system coupled to the process chamber and configured to introduce a cleaning gas a plasma source coupled to the process chamber and configure to form plasma from the cleaning gas, and a controller coupled to the process chamber and configured to execute a process recipe for dry cleaning the processing system periodically, wherein the process recipe substantially minimizes particulate formation during the dry cleaning.

According to another embodiment, a method of optimizing a dry cleaning process in a plasma processing system is presented comprising performing a dry cleaning process in the plasma processing system, wherein the dry cleaning process comprises introducing a process gas having oxygen (O2), setting a pressure in the plasma processing system, and igniting a plasma from the process gas; determining a first cleaning rate at a first location; determining a second cleaning rate at a second location; and adjusting the dry cleaning process in order to minimize a difference between the first cleaning rate and the second cleaning rate.

### BRIEF DESCRIPTION OF THE DRAWINGS

Embodiments of the invention will now be described, by way of example only, with reference to the accompanying schematic drawings, in which corresponding reference symbols indicated corresponding parts, and in which:

FIG. 1 shows a plasma processing system according to a preferred embodiment of the present invention;

FIG. 2 shows a plasma processing system according to one embodiment of the present invention;

FIG. 3 shows a plasma processing system according to another embodiment of the present invention;

FIG. 4 shows a plasma processing system according to a further embodiment of the present invention;

FIG. 5 shows a plasma processing system according to an additional embodiment of the present invention;

FIG. 6 shows a plasma processing system according to an additional embodiment of the present invention;

FIG. 7A shows a plasma processing system according to an additional embodiment of the present invention;

FIG. 7B shows a plasma processing system according to an additional embodiment of the present invention;

FIG. 8 shows a plasma processing system according to an additional embodiment of the present invention;

FIGS. 9A and 9B present data for a first design of experiment;

FIGS. 10A and 10B present data for a second design of experiment;

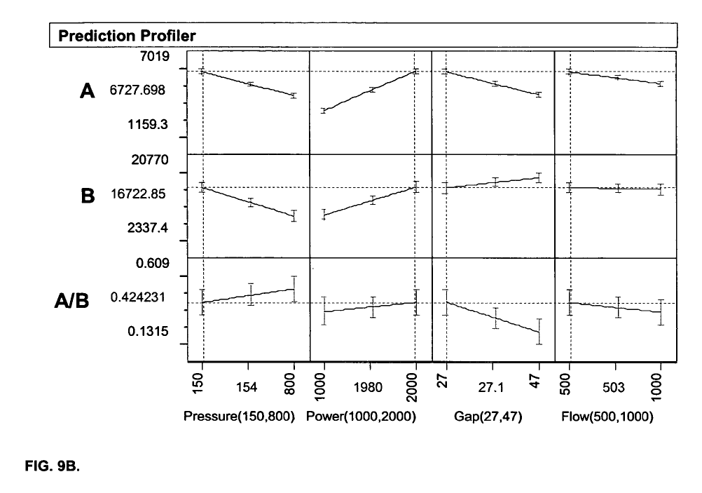

FIG. 11A shows endpoint data for a first dry cleaning process;

FIG. 11B shows endpoint data for a second dry cleaning process;

FIG. 12 illustrates a method of dry cleaning a plasma processing system according to an embodiment of the present invention; and

FIG. 13 illustrates a method of optimizing a dry cleaning process for a plasma processing system according to another embodiment of the present invention.

### DETAILED DESCRIPTION

During the formation of integrated circuits (ICs), material etching has been utilized to remove material from a substrate using physical and chemical processes. For instance, plasma processing systems can facilitate dry plasma etching to achieve this end. During processing in such systems, residue accumulates on interior surfaces exposed to the etch process. In order to achieve optimal yield, these surfaces require periodic cleaning, such as wet cleaning. However, wet cleaning can require time consuming procedures and, therefore, conventional practice has included in-situ dry cleaning of the plasma processing system in order to prolong the time between wet clean cycles.

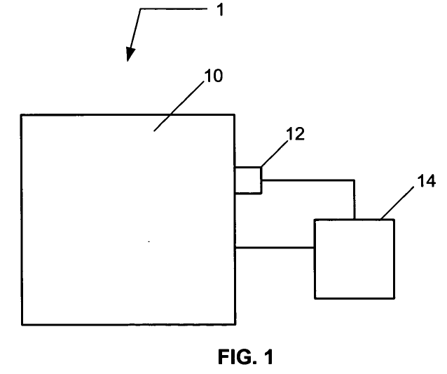

According to one embodiment, a plasma processing system 1 is depicted in FIG. 1, comprising a plasma processing chamber 10, a diagnostic system 12 coupled to the plasma processing chamber 10, and a controller 14 coupled to the diagnostic system 12 and the plasma processing chamber 10. The controller 14 is configured to execute at least one process recipe for etching a thin film, or features within a thin film, on a substrate, and at least one dry cleaning process recipe for dry cleaning the plasma processing system 1. Additionally, controller 14 is configured to receive at least one endpoint signal from the diagnostic system 12 and to post-process the received endpoint signal in order to accurately determine at least one of an endpoint for the etch process, and an endpoint for the dry cleaning process.

In the illustrated embodiment, plasma processing system 1, as depicted in FIG. 1, utilizes a plasma for material processing. Plasma processing system 1 can comprise an etch chamber, and ash chamber, or combination thereof.

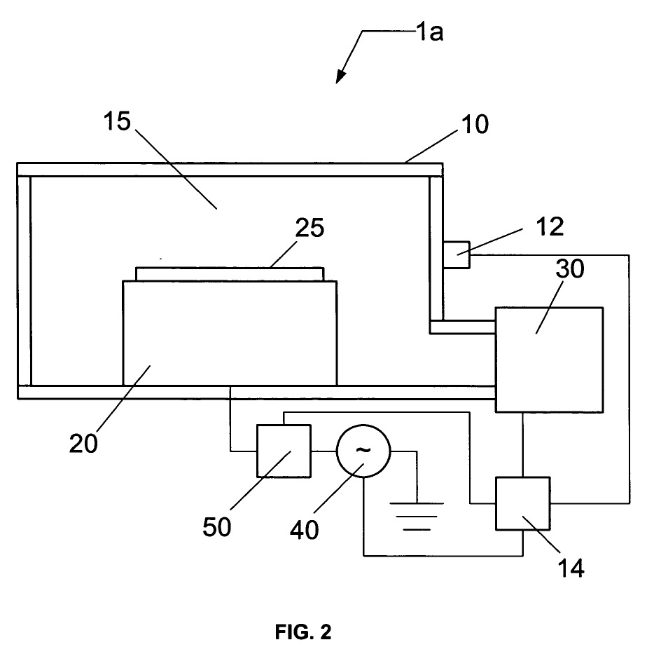

According to the embodiment depicted in FIG. 2, plasma processing system 1a can comprise plasma processing chamber 10, substrate holder 20, upon which a substrate 25 to be processed is held, and vacuum pumping system 30. Substrate 25 can be, for example, a semiconductor substrate, a wafer or a liquid crystal display. Plasma processing chamber 10 can be, for example, configured to facilitate the generation of plasma in processing region 15 adjacent a surface of substrate 25. An ionizable gas or mixture of gases is introduced via a gas injection system (not shown) and the process pressure is adjusted. For example, a control mechanism (not shown) can be used to throttle the vacuum pumping system 30. Plasma can be utilized to create materials specific to a pre-determined materials process, and/or to aid the removal of material from the exposed surfaces of substrate 25. The plasma processing system 1a can be configured to process 200 mm substrates, 300 mm substrates, or larger.

Substrate 25 can be, for example, held or affixed to the substrate holder 20 via an electrostatic clamping system. Furthermore, substrate holder 20 can, for example, further include a cooling system containing a re-circulating coolant flow that receives heat from substrate holder 20 and transfers heat to a heat exchanger system (not shown), or when heating, transfers heat from the heat exchanger system.

Moreover, gas can, for example, be delivered to the back-side of substrate 25 via a backside gas system to improve the gas-gap thermal conductance between substrate 25 and substrate holder 20. Such a system can be utilized when temperature control of the substrate is required at elevated or reduced temperatures. For example, the backside gas system can comprise a two-zone gas distribution system, wherein the helium gas gap pressure can be independently varied between the center and the edge of substrate 25. In other embodiments, heating/cooling elements, such as resistive heating elements, or thermoelectric heaters/coolers can be included in the substrate holder 20, as well as the chamber wall of the plasma processing chamber 10 and any other component within the plasma processing system 1a.

In the embodiment shown in FIG. 2, substrate holder 20 comprises an electrode through which RF power is coupled to the processing plasma in process space 15. That is, substrate holder 20 maybe electrically biased at a RF voltage via the transmission of RF power from a RF generator 40 through an impedance match network 50 to substrate holder 20. The RF bias can serve to heat electrons to form and maintain plasma. In this configuration, the system can operate as a reactive ion etch (RIE) reactor, wherein the chamber and an upper gas injection electrode serve as ground surfaces. A typical frequency for the RF bias can range from 0.1 MHz to 100 MHz. RF systems for plasma processing are well known to those skilled in the art.

Alternately, RF power may be applied to the substrate holder electrode at multiple frequencies. Furthermore, impedance match network 50 may serve to improve the transfer of RF power to plasma in plasma processing chamber 10 by reducing the reflected power. Match network topologies (e.g. L-type, □-type, T-type, etc.) and automatic control methods are well known to those skilled in the art.

Vacuum pump system 30 can, for example, include a turbo-molecular vacuum pump (TMP) capable of pumping speeds of up to 5000 liters per second (and greater) and a gate valve for throttling the chamber pressure. In conventional plasma processing devices utilized for dry plasma etch, a 1000 to 3000 liter per second TMP is generally employed. TMPs are useful for low pressure processing, typically less than 50 mTorr. For high pressure processing (i.e., greater than 100 mTorr), a mechanical booster pump and dry roughing pump can be used. Furthermore, a device for monitoring chamber pressure (not shown) can be coupled to the plasma processing chamber 10. The pressure measuring device can be, for example, a Type 628B Baratron absolute capacitance manometer commercially available from MKS Instruments, Inc. (Andover, Mass.).

Controller 14 comprises a microprocessor, memory, and a digital I/O port capable of generating control voltages sufficient to communicate and activate inputs to plasma processing system 1 a as well as monitor outputs from plasma processing system 1a. Moreover, controller 14 may be coupled to and may exchange information with RF generator 40, impedance match network 50, the gas injection system (not shown), vacuum pump system 30, as well as the backside gas delivery system (not shown), the substrate/substrate holder temperature measurement system (not shown), and/or the electrostatic clamping system (not shown). For example, a program stored in the memory may be utilized to activate the inputs to the aforementioned components of plasma processing system 1a according to a process recipe in order to perform the method of removing photoresist from a substrate. One example of controller 14 is a DELL PRECISION WORKSTATION 610™, available from Dell Corporation, Austin, Tex.

Controller 14 can be locally or remotely located relative to the plasma processing system 1a. For example, controller 14 can exchange data with plasma processing system 1a using a direct connection, an intranet, and the Internet, or a combination thereof. Controller 14 can be coupled to an intranet at, for example, a customer site (i.e., a device maker, etc.), or it can be coupled to an intranet at, for example, a vendor site (i.e., an equipment manufacturer). Additionally, for example, controller 14 can be coupled to the Internet. Furthermore, another computer (i.e., controller, server, etc.) can, for example, access controller 14 to exchange data via at least one of a direct connection, an intranet, and the Internet, or a combination thereof.

The diagnostic system 12 can include an optical diagnostic subsystem (not shown). The optical diagnostic subsystem can comprise a detector such as a (silicon) photodiode or a photomultiplier tube (PMT) for measuring the light intensity emitted from the plasma. The diagnostic system 12 can further include an optical filter such as a narrow-band interference filter. In an alternate embodiment, the diagnostic system 12 can include at least one of a line CCD. (charge coupled device), a CID (charge injection device) array, and a light dispersing device such as a grating or a prism. Additionally, diagnostic system 12 can include a monochromator (e.g., grating/detector system) for measuring light at a given wavelength, or a spectrometer (e.g., with a rotating grating) for measuring the light spectrum such as, for example, the device described in U.S. Pat. No. 5,888,337.

The diagnostic system 12 can include a high resolution Optical Emission Spectroscopy (OES) sensor such as from Peak Sensor Systems, or Verity Instruments, Inc. Such an OES sensor has a broad spectrum that spans the ultraviolet (UV), visible (VIS), and near infrared (NIR) light spectrums. The resolution is approximately 1.4 Angstroms, that is, the sensor is capable of collecting 5550 wavelengths from 240 to 1000 nm. For example, the OES sensor can be equipped with high sensitivity miniature fiber optic UV-VIS-NIR spectrometers which are, in turn, integrated with 2048 pixel linear CCD arrays.

Spectrometers receive light transmitted through single and bundled optical fibers, where the light output from the optical fibers is dispersed across the line CCD array using a fixed grating. Similar to the configuration described above, light emitting through an optical vacuum window is focused onto the input end of the optical fibers via a convex spherical lens. Three spectrometers, each specifically tuned for a given spectral range (UV, VIS and NIR), form a sensor for a process chamber. Each spectrometer includes an independent A/D converter. And lastly, depending upon the sensor utilization, a full emission spectrum can be recorded every 0.1 to 1.0 seconds.

The diagnostic system 12 can further include a plasma diagnostic system for optically monitoring particle concentration. For further details, an optical diagnostic system for monitoring particle concentration is described in pending U.S. Patent Provisional Application Ser. No. 60/429,067, entitled “Plasma processing system and method”, filed on Nov. 26, 2002; the entire contents of which are incorporated herein in their entirety.

The diagnostic system 12 can further include a thin film diagnostic system for optically measuring the thickness of a thin film on a process chamber component using thin film interferometry. The thin film measurement technique can, for example, utilize a spectrophotometer, or ellipsometer.

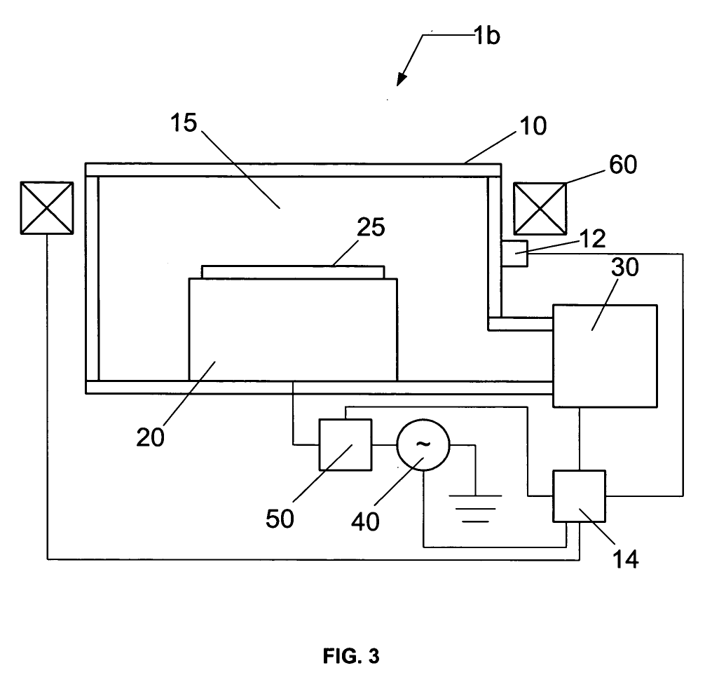

In the embodiment shown in FIG. 3, the plasma processing system 1b can, for example, be similar to the embodiment of FIG. 1 or 2 and further comprise either a stationary, or mechanically or electrically rotating magnetic field system 60, in order to potentially increase plasma density and/or improve plasma processing uniformity, in addition to those components described with reference to FIG. 2 and FIG. 3. Moreover, controller 14 can be coupled to magnetic field system 60 in order to regulate the speed of rotation and field strength. The design and implementation of a rotating magnetic field is well known to those skilled in the art.

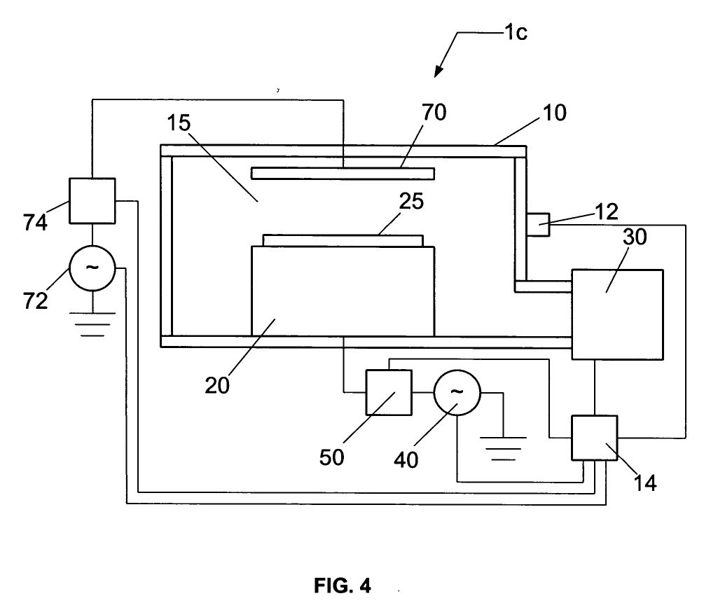

In the embodiment shown in FIG. 4, the plasma processing system 1c can, for example, be similar to the embodiment of FIG. 1 or FIG. 2, and further comprises an upper electrode 70 to which RF power can be coupled from RF generator 72 through impedance match network 74. A typical frequency for the application of RF power to the upper electrode can range from 0.1 MHz to 200 MHz. Additionally, a typical frequency for the application of power to the lower electrode can range from 0.1 MHz to 100 MHz. Moreover, controller 14 is coupled to RF generator 72 and impedance match network 74 in order to control the application of RF power to upper electrode 70. The design and implementation of an upper electrode is well known to those skilled in the art.

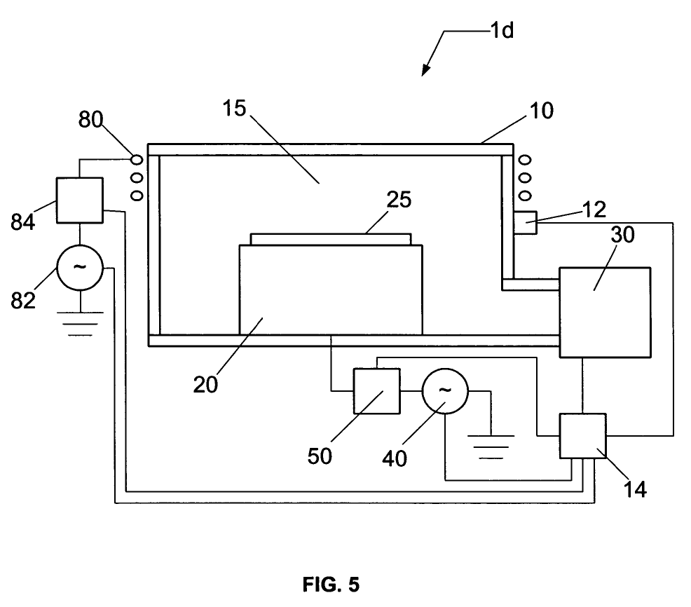

In the embodiment shown in FIG. 5, the plasma processing system 1d can, for example, be similar to the embodiments of FIGS. 1 and 2, and further comprises an inductive coil 80 to which RF power is coupled via RF generator 82 through impedance match network 84. RF power is inductively coupled from inductive coil 80 through dielectric window (not shown) to plasma processing region 45. A typical frequency for the application of RF power to the inductive coil 80 can range from 10 MHz to 100 MHz. Similarly, a typical frequency for the application of power to the chuck electrode can range from 0.1 MHz to 100 MHz. In addition, a slotted Faraday shield (not shown) can be employed to reduce capacitive coupling between the inductive coil 80 and plasma.

Moreover, controller 14 is coupled to RF generator 82 and impedance match network 84 in order to control the application of power to inductive coil 80. In an alternate embodiment, inductive coil 80 can be a “spiral” coil or “pancake” coil in communication with the plasma processing region 15 from above as in a transformer coupled plasma (TCP) reactor. The design and implementation of an inductively coupled plasma (ICP) source, or transformer coupled plasma (TCP) source, is well known to those skilled in the art.

Alternately, the plasma can be formed using electron cyclotron resonance (ECR). In yet another embodiment, the plasma is formed from the launching of a Helicon wave. In yet another embodiment, the plasma is formed from a propagating surface wave. Each plasma source described above is well known to those skilled in the art.

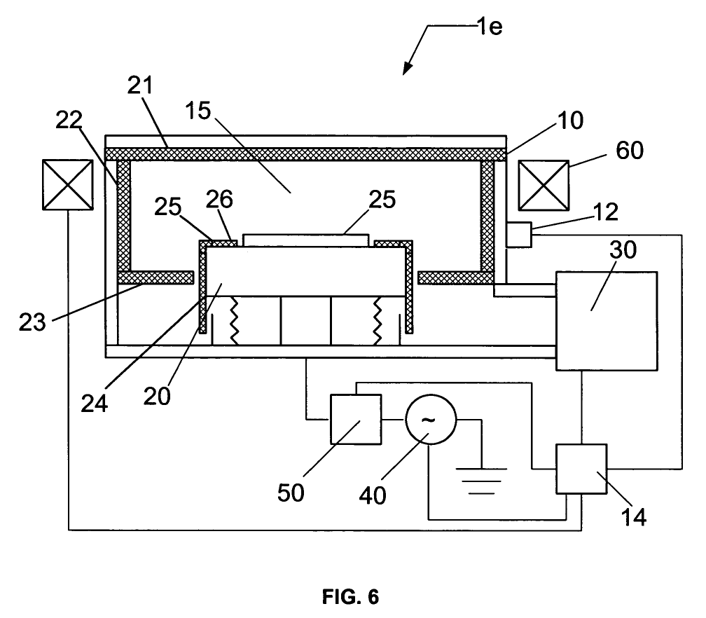

In another embodiment, the plasma processing systems, as illustrated in FIGS. 1 through 5, can further comprise replaceable components, designed, for example, to extend the life of more valuable processing chamber components. For example, FIG. 6 presents a plasma processing system 1e further comprising a replaceable electrode plate 21, a deposition shield 22, a baffle plate 23, a bellows shield 24, an edge ring 25, and a focus ring 26. Each of these replaceable components can be fabricated from at least one of stainless steel, aluminum, silicon, silicon carbide, silicon nitride, quartz, alumina, etc. Additionally, any one of these components can further comprise a coating, such as a surface anodization, a spray coating, or a coating formed via plasma electrolytic oxidation. The coating can comprise a layer of at least one of a III-column element and a Lanthanon element. The protective barrier can comprise at least one of Al₂O₃, Yttria (Y₂O₃), Sc₂O₃, Sc₂F₃, YF₃, La₂O₃, CeO₂, Eu₂O₃, DyO₃, and AIF. Methods of anodizing aluminum components and applying spray coatings are well known to those skilled in the art of surface material treatment.

As described earlier, plasma processing, such as etching, leads to the accumulation of residue on interior surfaces of the plasma processing system, including, for example, exposed surfaces of coated or non-coated replaceable components. In order to extend the time between wet cleaning of the plasma processing system, in-situ dry cleaning has been adopted to periodically clean the interior of the plasma processing system, for instance between substrate lots. Typically, an oxygen plasma is utilized to perform in-situ dry cleaning.

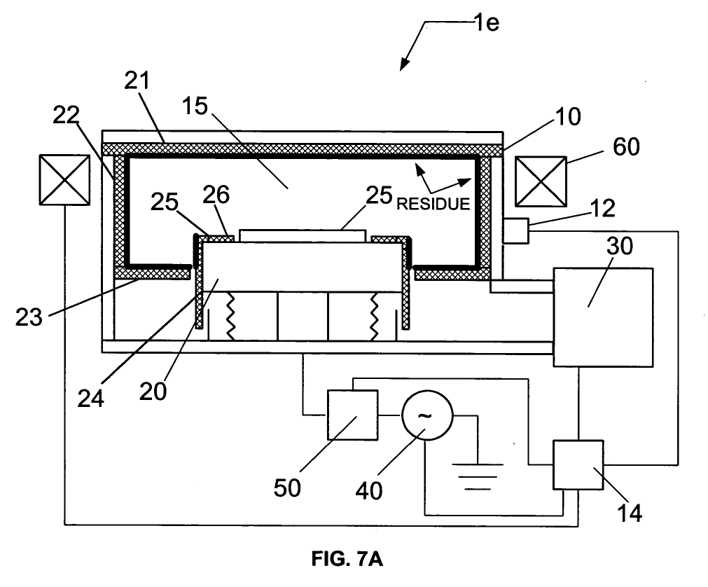

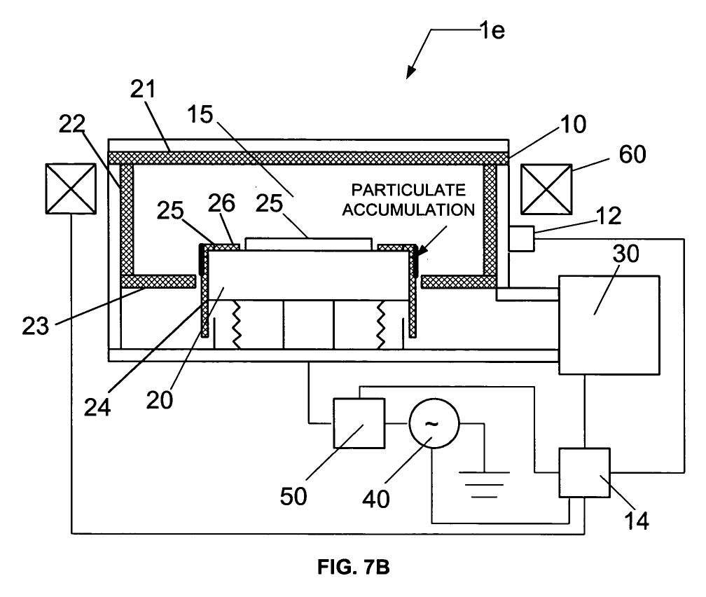

For example, dry cleaning using an oxygen plasma has been performed in a plasma processing system, such as the one described in FIG. 6, in order to remove residue that has accumulated on interior surfaces (see FIG. 7A). Therein, it has been purported that elevated pressure (>100 mTorr), and oxygen flow rate (>1000 sccm) affects a high cleaning rate. However, it has also been observed that such conditions lead to non-uniform cleaning rates, and subsequent sputtering of the underlying surfaces of the plasma processing system. The excessive oxygen ion sputtering of coated replaceable components has manifested as higher particulate concentrations, and particulate deposition on the exterior surfaces of the substrate holder, such as the bellows shield and edge ring (see FIG. 7B).

In an embodiment, the dry cleaning process is optimized for the plasma processing system in order to substantially reduce particulate formation during plasma processing. In another embodiment, the dry cleaning process is optimized for the plasma processing system in order to achieve a uniform cleaning rate. In yet another embodiment, the dry cleaning process is optimized for the plasma processing system to determine an endpoint of the dry cleaning process.

In a first example to achieve a uniform cleaning rate, a first design of experiment (DOE) was performed in a plasma processing system, such as the one depicted in FIG. 6, whereby several processing parameters were varied in order to determine the effect of such processing parameters on the cleaning rate and the uniformity of the cleaning rate. The processing parameters included the pressure, the cleaning gas flow rate, the (gap) spacing between the upper and lower electrodes, and the RF power (coupled to the substrate holder).

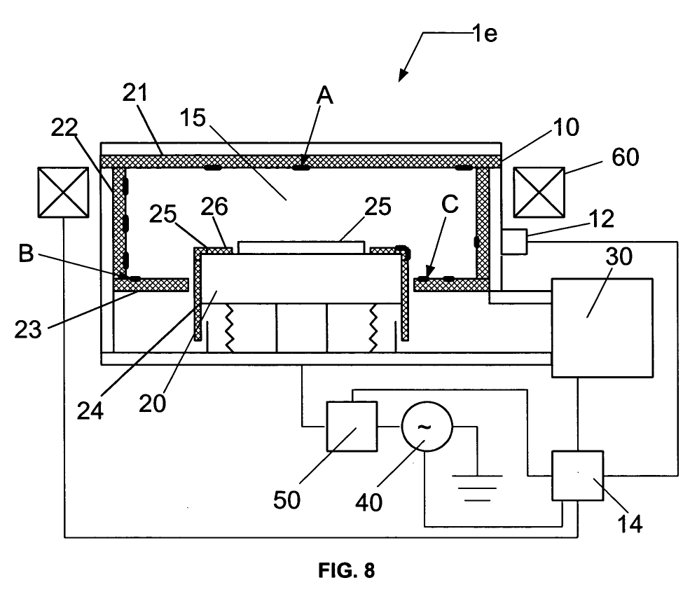

In order to simulate residue on the interior surface of the plasma processing system, a plurality of test specimens having a thin film of (organic) polymeric material were located at a plurality of locations within the interior of the plasma processing system. For instance, one (organic) polymeric material useful for simulating etch residue includes lithographic photoresist. FIG. 8 illustrates an exemplary distribution of test specimens in a plasma processing system.

Now, using the set of test specimens, the first DOE is performed to determine the dry cleaning rate, and uniformity of the dry cleaning rate in the plasma processing system. Table 1 presents the DOE factor and level summary for this example, wherein the gap spacing represents the distance between the upper electrode and the lower electrode (4-factor, 2-level).

Following the set of experiments, the center of the upper electrode (site A) and the outer edge of the baffle plate (site B) were determined to represent the sites of minimum and maximum cleaning rates, respectively. From this, a summary response was developed to describe chamber uniformity, i.e., the ratio of cleaning rates A/B, whereby the desired value being 1.0.

TABLE 1

| FACTOR | (−) LEVEL | (0) CENTER POINT | (+) LEVEL |
|---|---|---|---|
| Pressure (mTorr) | 150 | 475 | 800 |
| Power (W) | 1000 | 1500 | 2000 |
| O₂ flow rate (sccm) | 500 | 750 | 1000 |
| Gap spacing (mm) | 27 | 37 | 47 |

A least squares fit of chamber uniformity effects, estimated at low (150 mTorr) and high (800 mTorr) pressure levels, indicates that the gap has a (−) effect for chamber uniformity, indicating minimum gap for best uniformity. Secondly, pressure is a (+) effect for chamber uniformity, suggesting higher pressure will provide improved chamber uniformity. However, high-pressure processes indicate a lower average cleaning rate (reduced by approximately 30%) when compared to low pressure processes. Other effects for chamber uniformity improvement are (−) flow and (+) RF power.

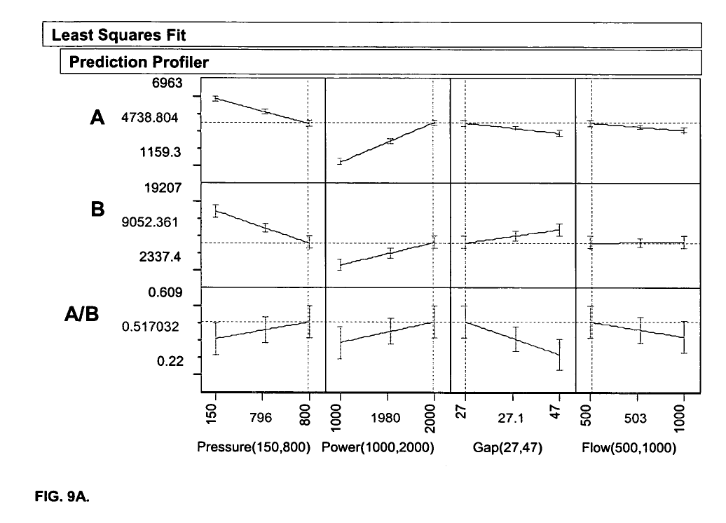

The least squares, linear model is utilized to produce a predictor profile to illustrate estimated responses for preferred levels of pressure, power, gap, and flow rate. In this case, the preferred levels are predicted to provide an improvement to dry cleaning uniformity from conventional processes, i.e., an increase of A/B from 0.36 to 0.42. FIGS. 9A and 9B illustrate the dry cleaning uniformity for low and high pressure levels within the range of 150 mTorr and 800 mTorr (see Table 1).

In order to investigate the effects of lower pressure, a second DOE was performed, wherein the pressure was varied from 50 mTorr to 150 mTorr and the effect of the gap spacing (set to 27 mm) was eliminated from the DOE. Table 2 presents the DOE factor and level summary for this example. From the results, the center of the upper electrode (site A) and the outer edge of the baffle plate (site B) were determined to represent the sites of minimum and maximum cleaning rates, respectively. From this, a summary response was developed to describe chamber uniformity, i.e., the ratio of cleaning rates A/B, whereby the desired value being 1.0. Additionally, the outer edge of the baffle plate (site B) and the inner edge of the baffle plate (site C) were determined to represent the sites of maximum and minimum cleaning rates on the baffle plate, respectively.

TABLE 2

| FACTOR | (−) LEVEL | (0) CENTER POINT | (+) LEVEL |
|---|---|---|---|
| Pressure (mTorr) | 50 | 100 | 150 |
| Power (W) | 3000 | 3500 | 4000 |
| O₂ flow rate (sccm) | 500 | 1000 | 1500 |

A least squares fit of the plasma processing system uniformity (A/B), and the baffle plate uniformity (B/C) indicates that the pressure is a primary effect, with oxygen flow rate estimated to be a secondary effect. Utilizing a prediction profiler, processing system and baffle plate uniformity and uniformity trends are estimated at low (50 mTorr) and high (150 mTorr) pressure levels. The results of the second DOE indicate that processing system and baffle plate uniformity can be improved by reducing pressure below 100 mTorr, and reducing the oxygen flow rate, while operating at elevated RF power and reduced gap. For example, in the plasma processing system depicted in FIG. 6, the preferred dry cleaning process was a pressure of 50 mTorr, a power of 4000 W, and an oxygen mass flow rate of 500 sccm.

In a second example to reduce particulate formation, endpoint detection is utilized to determine when the dry cleaning process is complete. The endpoint detection method for determining when a dry clean is complete can include monitoring light emission from the dry clean plasma using, for example, optical emission spectroscopy (OES). For instance, the OES system can be configured to monitor CO (482.5 or 561 nm) emission, a major by-product of the dry clean process. As the oxygen plasma reacts with surface polymer, CO is produced and CO emission spectra can be monitored. As surface polymer is removed and the source for CO becomes extinguished, CO emission intensity generally decreases, and it is this change from which a dry clean endpoint can be defined. Since different etch applications produce varying amounts of polymer to be removed, the required dry clean time can vary based on the preceding etch application, in addition to the number of substrates in a given lot. Endpoint can be used to determine when polymer deposition is sufficiently removed and when the dry clean can be terminated to avoid excessive sputtering of exposed ceramic surfaces.

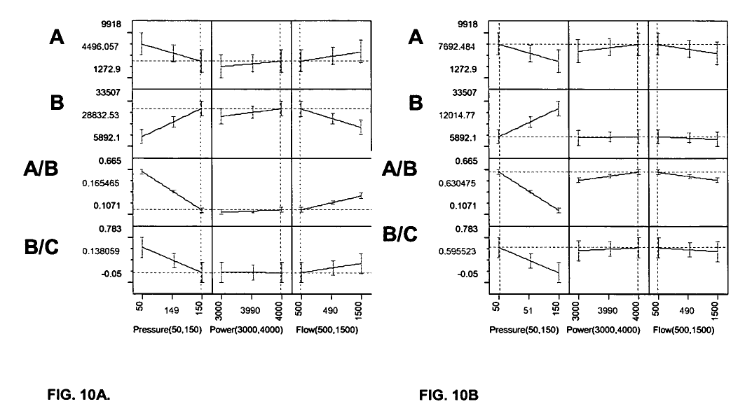

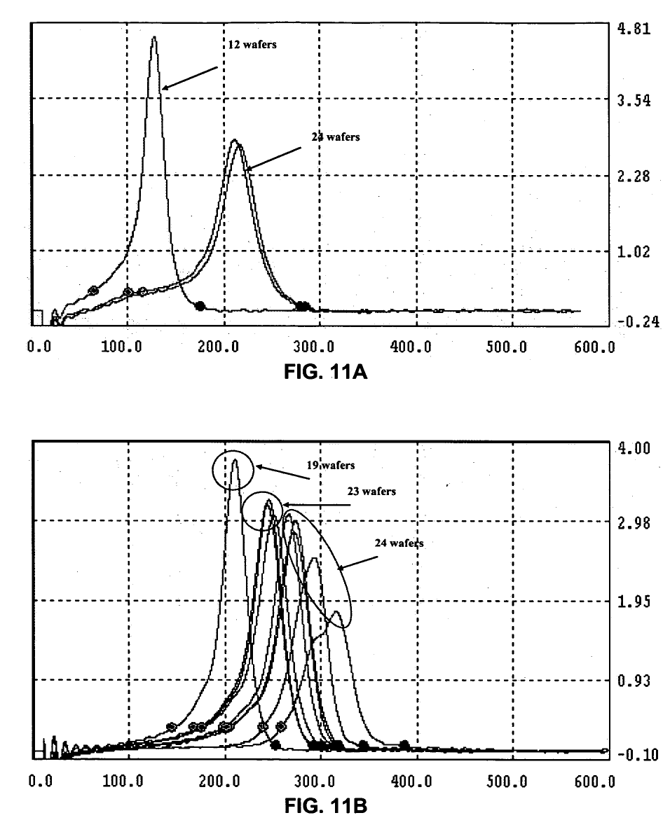

For instance, FIGS. 11A and 11B show endpoint detection results for post trench etch dry cleaning, and post via etch dry cleaning, respectively. The abscissa represents time (seconds), and the ordinate represents the endpoint signal (i.e., the absolute value of the slope of the signal proportional to light emission for CO). It will be appreciated that the endpoint time increases with the size of the substrate lot. For instance, during post trench etch dry cleaning, the endpoint increases from approximately 125 seconds to 210 seconds when the substrate lot increases from 12 substrates to 24 substrates.

In one embodiment, the dry cleaning process is terminated following the detection of endpoint. In an alternate embodiment, the dry cleaning process further comprises an over clean process, wherein the over clean process extends the dry cleaning time beyond the detection of endpoint. For instance, the over clean time period can constitute a fraction of the dry cleaning process time from initiation to endpoint detection.

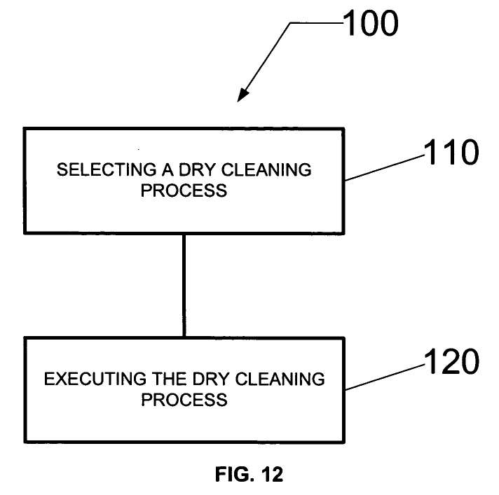

Referring to FIG. 12, a method of dry cleaning a plasma processing system is described. The method is illustrated in a flow chart 100 beginning at task 110 with selecting a dry cleaning process. The dry cleaning process can be selected to substantially reduce particulate formation in the plasma processing system. Alternately, the dry cleaning process can be selected to substantially reduce particulate formation for particles larger than 0.5 micron, for particles larger than 0.16 micron, substantially reduce particulate formation to a particle count per substrate of less than 10 particles, or substantially maximize the uniformity of the dry cleaning process in the plasma processing system. Alternately, the dry cleaning process can be selected to substantially maximize the uniformity of the dry cleaning process across a specific component. The particle concentration (or number of particles) can be determined either in-situ using an optical monitoring system such as that described above, or ex-situ by utilizing a particle detection system for monitoring particulate on the substrate surface, such as laser scatterometry.

In task 120, the selected dry cleaning process is executed in the plasma processing system. The dry cleaning process can be terminated following a pre-specified period of time. Alternately, the dry cleaning process can be terminated following the detection of endpoint. Alternately, the dry cleaning process can be terminated following an over clean time period extending beyond the detection of endpoint.

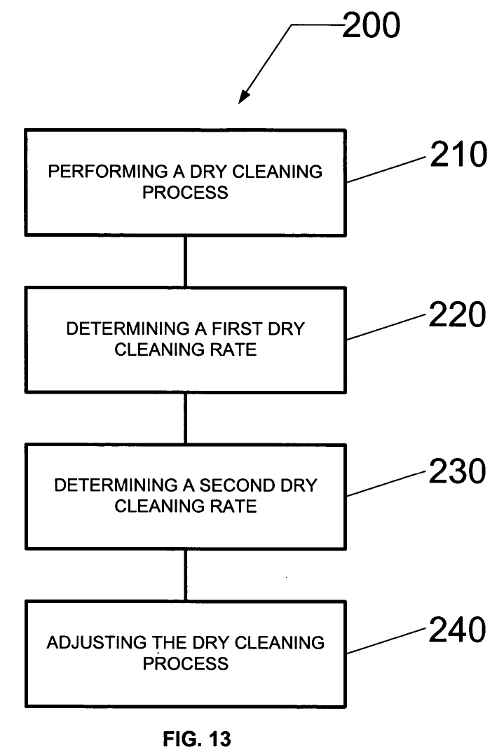

Referring now to FIG. 13, a method of optimizing a dry cleaning process is described. The method is illustrated in a flow chart 200 beginning at task 210 with performing a dry cleaning process in a plasma processing system. The dry cleaning process can include a pre-specified process recipe, a process of record (POR), etc.

In task 220, a dry cleaning rate is determined at a first location in the plasma processing system. The dry cleaning rate can be measured by determining the change in thickness of the residual film at the first location, and the time required during dry cleaning to attain the change in thickness. The film thickness can be measured ex-situ using techniques as described above, or it can be measured in-situ using a film thickness monitor such as a film thickness interferometer.

In task 230, a dry cleaning rate is determined at a second location in the plasma processing system.

In task 240, the dry cleaning process is adjusted in order to substantially reduce the difference between the first cleaning rate at the first position and the second cleaning rate at the second position. The adjustment of the dry cleaning process can include the adjustment of at least one of a pressure, a power, a flow rate, and a gap spacing.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

Thus, the description is not intended to limit the invention and the configuration, operation, and behavior of the present invention has been described with the understanding that modifications and variations of the embodiments are possible, given the level of detail present herein. Accordingly, the preceding detailed description is not meant or intended to, in any way, limit the invention—rather the scope of the invention is defined by the appended claims.

1. A method of dry cleaning a plasma processing system comprising:
selecting a dry cleaning process recipe for substantially reducing particulate contamination during said dry cleaning of said plasma processing system, wherein said dry cleaning process recipe comprises setting at least one of a mass flow rate of a process gas, a pressure for said dry cleaning process, and a power for forming a plasma from said process gas; and
executing said dry cleaning process recipe in said plasma processing system to facilitate said dry cleaning.

2. The method of claim 1, further comprising selecting a dry cleaning process recipe for substantially reducing variations of dry cleaning rates in said plasma processing system.

3. The method of claim 1, further comprising terminating said dry cleaning process following a detection of an endpoint of said dry cleaning process.

4. The method of claim 1, further comprising terminating said dry cleaning process following an over clean time period extending beyond a detection of an endpoint of said dry cleaning process.

5. The method of claim 3, wherein said terminating said dry cleaning process following said detection of said endpoint comprises using optical emission spectroscopy.

6. The method of claim 1, wherein said setting said pressure comprises setting said pressure at a value less than or equal to 100 mTorr.

7. The method of claim 1, wherein said setting said mass flow rate of said process gas comprises setting a mass flow rate of oxygen (O₂).

8. The method of claim 1, wherein said selecting said dry cleaning process recipe comprises performing a design of experiment.

9. The method of claim 1, wherein said selecting said dry cleaning process recipe comprises substantially reducing particles of 0.5 micron and larger.

10. The method of claim 9, wherein said substantially reducing particles of 0.5 micron and larger comprises reducing the number of said particles to less than or equal to 10 particles per substrate.

11. The method of claim 1, further comprising monitoring a particle concentration in said plasma processing system.

12. The method of claim 11, further comprising adjusting said process recipe according to said particle concentration.

13. The method of claim 11, wherein said monitoring said particle concentration includes using laser scatterometry.

14. The method of claim 1, further comprising monitoring a cleaning rate uniformity in said plasma processing system.

15. The method of claim 14, further comprising adjusting said process recipe according to said cleaning rate uniformity.

16. A plasma processing system for processing a substrate comprising:
a process chamber;
a substrate holder coupled to said process chamber and configured to support said substrate;
a gas injection system coupled to said process chamber and configured to introduce a cleaning gas;
a plasma source coupled to said process chamber and configure to form plasma from said cleaning gas; and
a controller coupled to said process chamber and configured to execute a process recipe for dry cleaning said processing system periodically, wherein said process recipe substantially minimizes particulate formation during said dry cleaning.

17. The plasma processing system of claim 16, further comprising a diagnostic system coupled to said process chamber and said controller configured to perform at least one of monitoring light emission from said plasma processing system, monitoring particle concentrations in said plasma processing system, and monitoring a thickness of a film on an interior surface of said plasma processing system.

18. A method of optimizing a dry cleaning process in a plasma processing system, comprising:
performing a dry cleaning process in said plasma processing system, wherein said dry cleaning process comprises introducing a process gas having oxygen, setting a pressure in said plasma processing system, and igniting a plasma from said process gas;
determining a first cleaning rate at a first location;
determining a second cleaning rate at a second location; and
adjusting said dry cleaning process in order to minimize a difference between said first cleaning rate and said second cleaning rate.

19. The method of claim 18, wherein said determining said first cleaning rate and said second cleaning rate includes installing a first test specimen at said first location prior to performing said dry cleaning process, installing a second test specimen at said second location prior to said performing said dry cleaning process, removing said first test specimen following said dry cleaning process, measuring a thickness of a film on said first test specimen, removing said second test specimen following said dry cleaning process, and measuring a thickness of a film on said second test specimen.

20. The method of claim 18, wherein said determining said first cleaning rate and said second cleaning rate includes utilizing an in-situ thin film interferometer.
